(19) United States
(12) Patent Application Publication
(10) Pub. No.: US 2018/0259116 A1
(43) Pub. Date: Sep. 13, 2018

(54) HINGED DEVICE HAVING A FREE END INTENDED TO SUPPORT A CANTILEVERED LOAD

(71) Applicants: Richard Chene, Neuilly (FR); Dominique Delamour, Les Mesnuls (FR); Alain Miklitarian, Paris (FR)

(72) Inventor: Dominique Delamour, Les Mesnuls (FR)

(21) Appl. No.: 15/761,017

(22) PCT Filed: Sep. 16, 2016
(86) PCT No.: PCT/EP2016/071931

§ 371 Date: Mar. 16, 2018

(30) Foreign Application Priority Data
Sep. 16, 2015 (FR) 1558703

(51) Int. Cl. F16M 11/20; F16M 11/10

(52) U.S. Cl. CPC F16M 11/2021; F16M 2200/044; F16M 11/10

(57) ABSTRACT

The invention relates to a hinged device having a free end intended to support a cantilevered load, the device having at least a first element and a second element that are connected by a hinge comprising a cylinder secured to said first element and a housing secured to said second element, which are hinged together about an axis of said cylinder, the hinge having at least a first tension spring and a second tension spring, each tension spring having an end connected to the second element and an end connected to the cylinder of the first element at a fastening point, the fastening points of the tension springs being separate from one another and situated away from the cylinder axis so as to generate a torque about said cylinder axis between the first element and the second element in order to oppose the torque brought about by the cantilever.

### TECHNICAL FIELD

The present invention relates to the field of hinged devices comprising a free end intended to support a cantilevered load, for example, an architect's lamp intended to support a lamp head.

In a known manner, a lamp of the aforementioned type comprises a base, a lamp head and a hinged body to connect the base to said lamp head. In practice, the base of the lamp is weighted or fixed to a worktable. Thanks to the hinged body, it is possible to move the lamp head to the desired place of a workstation while the base remains fixed to said worktable.

When the lamp head is distant from the base, the hinged body is tilted and must support the mass of the lamp head. In order to avoid a movement towards the bottom of the hinged body under the effect of the weight of the lamp head, the hinged body is equipped with tension springs in order to create a lever arm. In practice, a lever arm has a protruding dimension of around 3 to 5 cm from the hinged body, which has a disadvantage from an aesthetic point of view. Also, there is a desire to obtain a hinged body with no protruding lever arm, while being capable of supporting a cantilevered lamp head.

In order to resolve this disadvantage, it has been proposed in the prior art to integrate a linkage system in a hinged body as defined by the patent application U.S. Pat. No. 4,494,177A. However, without mentioning the complexity thereof, such a linkage system limits the tilt amplitude and has an increased cost.

The invention therefore aims to remedy these disadvantages by proposing a hinged device comprising a free end intended to support a cantilevered load which has no protruding lever arm, while being of a simple and inexpensive design, in order to enable the easy movement thereof into a stable position.

Although the invention came about originally for an architect's lamp, it aims for any hinged device comprising a free end intended to support a cantilevered load, in particular, an industrial handling arm.

### SUMMARY

To this end, the invention relates to a hinged device comprising a free end intended to support a cantilevered load, the device comprising at least one first element and a second element connected by a hinge comprising a cylinder secured to said first element and a housing secured to said second element which are hinged together along an axis of said cylinder, the hinge comprising at least one first tension spring and a second tension spring, each tension spring having an end connected to the second element and an end connected to the cylinder of the first element according to a fastening point, the fastening points of the tension springs being separate from one another and situated away from the cylinder axis so as to generate a torque around said cylinder axis between the first element and the second element in order to oppose the torque brought about by the cantilever.

Because of the weight of the second element and of a possible mass fastened to the end thereof, a drive torque, brought about by the cantilever, tends to make the second element turn in relation to the first element along a cylinder axis. Thanks to the assembly according to the invention, the tension springs enable to generate a tension torque opposing the drive torque in order to keep the second element immobile. Using two springs further enables to improve the performance to the functioning limits of each spring taken independently. Thanks to the invention, the second element can be moved without any force, by pushing it or by pulling it, in a stable position, in the manner of a device according to the prior art comprising a lever arm of a significant length and protruding. Advantageously, the hinged device according to the invention has a low volume, an improved aesthetic, and a limit production cost.

Preferably, the first tension spring and the second tension spring extend longitudinally, each tension spring comprising a helicoidal body, the helicoidal body of the first tension spring and the helicoidal body of the second tension spring are longitudinally offset. Advantageously, the tension springs extend into a cavity of the second element. Thus, the tension springs can be assembled in the second element practically, the helicoidal bodies being distributed longitudinally.

According to a preferred aspect, the fastening points of the tension springs are situated at the same distance from the cylinder axis. Thus, the tension torque generated is balanced so as to apply tension springs symmetrically.

Preferably, the fastening points of the tension springs are spread in relation to the cylinder axis by a non-zero spread angle. Thus the springs act differently according to the tilt of the elements.

Preferably, the fastening points of the tension springs are spread in relation to the cylinder axis by a spread angle of between 40° and 60° in order to compensate for the mass of the second element over a large angular range of the hinge tilting.

Advantageously, the tension springs are configured to flatten the cylinder against the housing in order to generate a friction force limiting the rotation of the first element in relation to the second element around said cylinder axis. In other words, the tension torque and the friction force enable to oppose the drive torque of the second element supporting a cantilevered mass.

Preferably, the cylinder and the housing comprise stainless steel contact surfaces. This is particularly advantageous, given that the static friction torque is higher than the dynamic (kinetic) friction torque, which enables the second element to be easily moved between the stable positions.

Preferably, at least 120° of the peripheral surface of the cylinder is flattened against the housing in order to generate a friction force.

According to a preferred aspect, the cylinder comprises two cylindrical portions, axially offset along the cylinder axis so as to conserve between them, an assembly slot for the tension springs. Thus, the tension springs are integrated into the cylinder volume, which limits the volume and improves the integration.

Preferably, the device comprises an electrical connection cable extending between the first element and the second element through the hinge. Thus, a lamp head connected to the second element can be powered electrically. Preferably, the electrical connection cable extends into the respective cavities of the first and second element, preferably again, with the tension springs.

Advantageously, the electrical connection cable extends into said assembly slot.

Preferably, the first element and the second element being connected by a first hinge, the device comprises a third element connected to the second element by a second hinge, similar to the first hinge which comprises a second cylinder secured to said third element and a second housing secured to said second element which cooperates along the axis of said second cylinder.

Preferably, the second element comprises all the tension springs in order to limit the mass of the third element. Preferably, the third element is connected to a lamp head.

In a preferred manner, a covering jacket is assembled externally to the second element, so as to improve the aesthetic aspect. In other words, the mechanical aspect (second element) and aesthetic aspect (covering jacket) are separate, so as to obtain devices of different aspects from one same second element, which is advantageous.

According to a preferred aspect, the device according to the invention is presented in the form of a lamp.

According to another preferred aspect, the device according to the invention is presented in the form of a handling arm.

### BRIEF DESCRIPTION OF THE DRAWINGS

The invention will be best understood upon reading the following description, only given as an example, and by referring to the appended drawings, whereon:

FIG. 1 is a schematic representation of two separate configurations of an architect's lamp according to the invention;

FIG. 2 is an exploded, perspective, schematic representation of a first hinge;

FIG. 3 is a cross-section, schematic representation of a first hinge;

FIG. 4 is another cross-section, schematic representation of the first hinge according to a first tilt;

FIG. 5 is another cross-section, schematic representation of the first hinge according to a second tilt;

FIG. 6 is a perspective, schematic representation of a second hinge; and

FIGS. 7 to 9 are schematic representations of several configurations of an architect's lamp.

It must be noted, that the figures describe the invention in a detailed manner to implement the invention, said figures could, of course, serve to best define the invention, if necessary.

### DETAILED DESCRIPTION

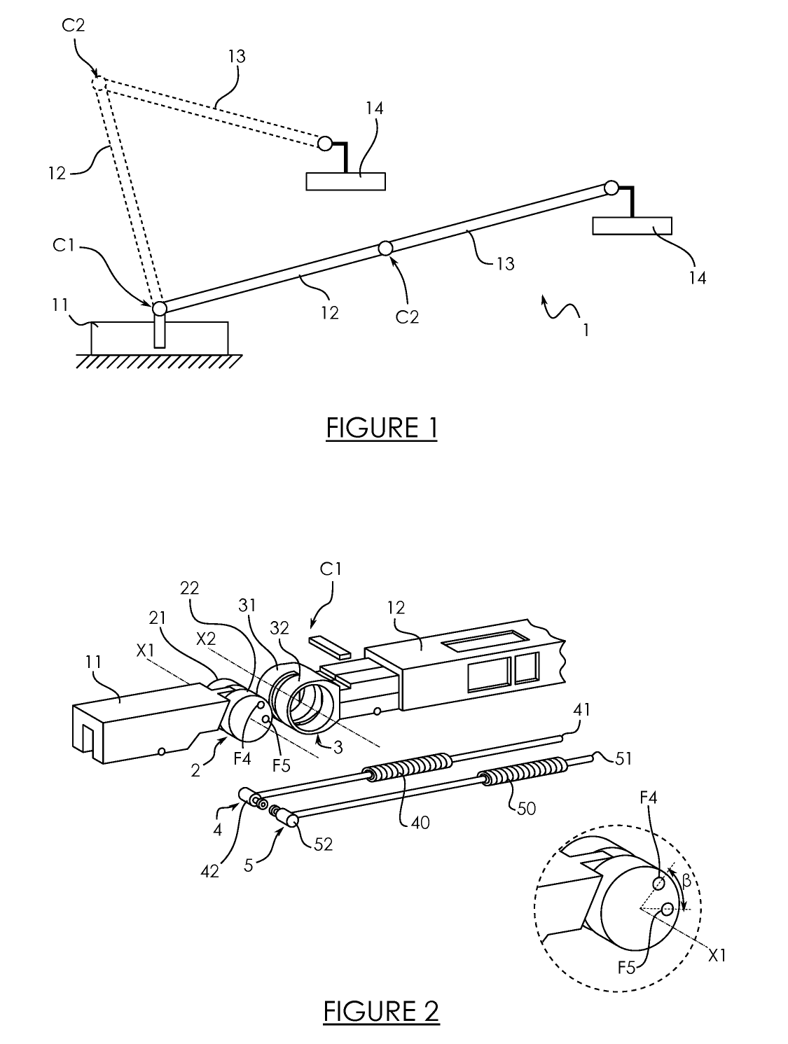

In reference to FIG. 1, an architect's lamp 1 is represented, which comprises a first element 11 forming a base, a second element 12 hinged to said first element 11 by a first hinge C1, a third element 13 hinged to said second element 12 by a second hinge C2 and a fourth element 14 forming a lamp head 14 which is connected to said third element 13.

In the example of implementation, the second element 12 and the third element 13 each have a length of between 400 mm and 550 mm, preferably between 450 mm and 500 mm. Preferably still, the second element 12 and the third element 13 each have a section diameter of around 10 mm.

The second element 12 and the third element 13 form a hinged arm enabling the lamp head 14 to be moved in relation to the base according to several configurations. In this example, in reference to FIG. 1, the lamp head 14 extends substantially above the base according to a folded configuration and is distant from said base according to an extended configuration.

As will subsequently be presented, the hinges C1, C2 are assembled symmetrically, in order to concentrate their volume in the second element 12, the other elements 11, 13 thus being of a simple design. To be clear, only the first hinge C1 will henceforth be presented in detail, with the second hinge C2 being similar to the first hinge C1.

In reference to FIG. 2 representing an exploded view, the first hinge C1 comprises a first cylinder 2 secured to said first element 11 and a first housing 3 secured to said second element 12. The cylinder 2 is assembled in said first housing 3 in order to be hinged together along the axis X1 of said first cylinder 2 which will be subsequently named “first cylinder axis X1”. Likewise, as illustrated in FIG. 7, we subsequently define a first tilt angle S21 between the first element 11 and the second element 12 and a second tilt angle S22 between the second element 12 and the third element 13. The first hinge C1 here has a conic tilt angle of around 40° whereas the second hinge C2 has a conic tilt angle of around 50°.

The first hinge C1 comprises a first tension spring 4 and a second tension spring 5. As illustrated in FIGS. 4 and 5, each tension spring 4, 5 has an end 41, 51 connected to the second element 12 and an end 42, 52 connected to the first cylinder 2 of the first element 11 according to a fastening point F4, F5, the fastening points F4, F5 of the tension springs 4, 5 being separate from one another and situated away from the first cylinder axis X1 so as to generate a tension torque around said first cylinder axis X1 between the first element 11 and the second element 12 as will subsequently be presented.

In a preferred manner, each tension spring 4, 5 has a length of between 60 mm and 80 mm and a maximum extension length of between 12 and 15 mm. Preferably, the diameter of each tension spring 4, 5 is less than 4.5 mm in order to be housed in said elements 12, 13.

Preferably, the tension springs 4, 5 are connected to the first cylinder 2 through rods, but it goes without saying that they could be assembled directly to the latter.

As illustrated in FIG. 2, in particular on the enlarged portion of this figure, the fastening points F4, F5 of the tension springs 4, 5 are spread out in relation to the cylinder axis X1 at a spread angle β of between 40° and 60°, preferably still, around 50° in order to be able to create a lever arm and make said first cylinder 2 turn in relation to the cylinder axis X1 thereof, as will subsequently be presented. Such a spread angle β has the advantage of defining an angular range wherein the tension springs act simultaneously over the handling range of the lamp in order to obtain a stable position. In addition, the springs enable to be compensated for, when the extreme positions of a tension spring 4, 5 are reached. Finally, such a spread angle β enables to form an optimal stress force to generate friction ensuring stability.

As illustrated in FIGS. 4 and 5, the fastening points F4, F5 of the tension springs 4, 5 are situated at the same distance from the cylinder axis X1 and away from said cylinder axis X1 such that the tension springs 4, 5 contribute symmetrically, which improves the lifespan of the first hinge C1. Preferably, the fastening points F4, F5 are situated at a distance of less than 6 mm from the cylinder axis X1.

In this example, as illustrated in FIG. 2, the first cylinder 2 comprises two cylindrical portions 21, 22 axially offset along the cylinder axis X1 so as to conserve between them a slot 23 to enable the assembly of the two tension springs 4, 5. Still in reference to FIG. 2, the first housing 3 comprises two cylindrical loops 31, 32 axially offset along the cylinder axis X1 in order to cooperate with the cylindrical portions 21, 22 of the first cylinder 2. In other words, each cylindrical portion 21, 22 is guided in a cylindrical loop 31, 32 in order to guide the hinge along the cylinder axis X1 of the first element 11 in relation to the second element 12.

In a preferred manner, the tension springs 4, 5 are respectively connected to the cylindrical portions 21, 22 of the cylinder 2 so as to enable a balanced guiding.

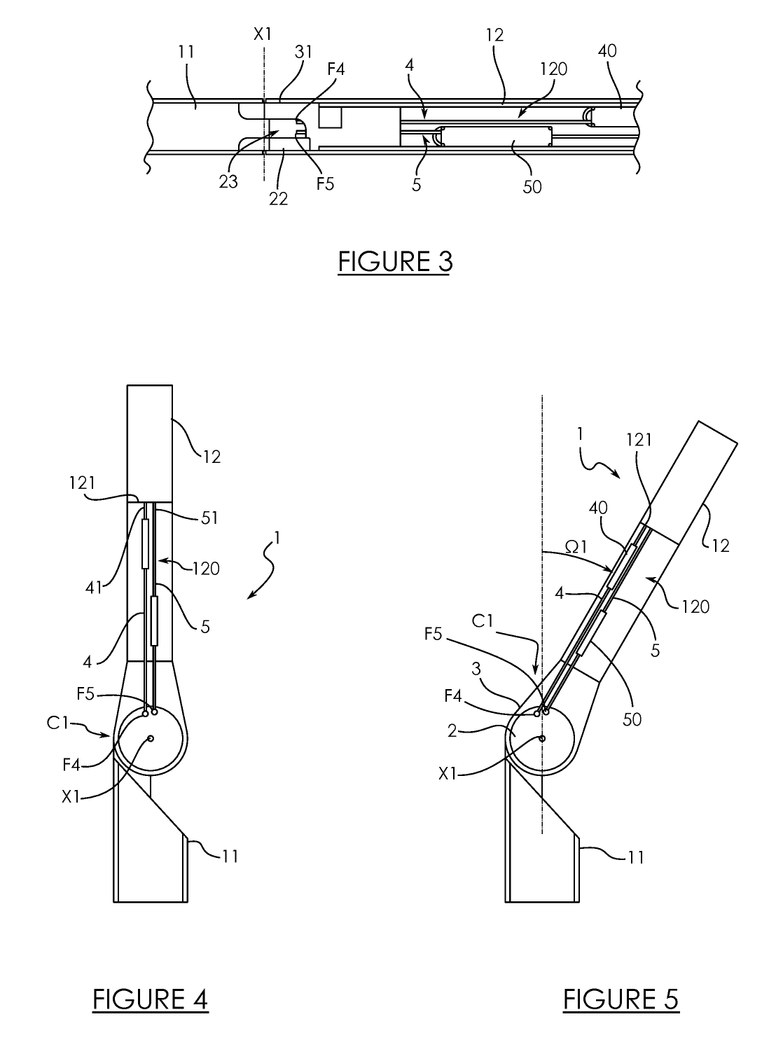

In reference to FIGS. 3 to 5, the second element 12 comprises a longitudinal cavity 120 wherein the tension springs 4, 5 are housed in order to be integrated to the second element 12. In other words, in this embodiment, the tension springs 4, 5 are assembled internally in the assembly slot 23 of the first cylinder 2, but it goes without saying that the assembly could be different. For example, the assembly could be achieved externally to the first cylinder 2. As illustrated in FIGS. 4 and 5, the second element 12 comprises, in the longitudinal cavity 120 thereof, a connecting member 121 whereon are connected the ends 41, 51 of the tension springs 4, 5. In a preferred manner, the position of the connecting member 121 is adjustable in the longitudinal cavity 120 in order to adjust the tension of the tension springs 4, 5.

The tension springs 4, 5 are configured to flatten the cylinder 2 against the housing 3 in order to generate a friction force limiting the rotation of the first element 11 in relation to the second element 12 around said cylinder axis X1.

Preferably, at least 120° of the peripheral surface of the cylinder 2 is flattened against the housing 3 in order to generate a sufficient friction force to immobilise the second element 12 in relation to the first element 11. In order to enable a consistent friction while limiting wear and tear, the cylinder 2 and the housing 3 comprise stainless steel contact surfaces.

In a preferred manner, the cylindrical loops 31, 32 which form the housing 3 are adjustable so as to control the friction force of the first housing 3 with the first cylinder 2. In reference to FIG. 2, the first hinge C1 comprises means 8 for adjusting the peripheral length of the cylindrical loops 31, 32 in order to adjust the friction force of the first housing 3 with the first cylinder 2. In other words, the cylindrical loops 31, 32 form a band brake.

In reference to FIG. 2, the first tension spring 4 and the second tension spring 5 extend longitudinally and each comprise a helicoidal body 40, 50, known as a “coil”, an end 41, 51 connected to the second element 12 and an end 42, 52 connected to the first cylinder 2. In this example, the ends 41, 51, 42, 52 are presented in the form of wires. In reference to FIGS. 3 to 5, the helicoidal bodies 40, 50 of the tension springs 4, 5 are longitudinally offset so as to limit their transversal volume and thus enable their assembly in the same longitudinal cavity 120 of the second element 12. Such a characteristic is particularly advantageous in the case of a lamp wherein it is necessary to reserve the space for the passing of an electrical power cable 9 into the second element 12.

In a preferred manner, the tension springs 4, 5 have a constant spring of between 0.9 dN·mm⁻¹ and 1.5 dN·mm⁻¹. Such tension springs 4, 5 enable to work with an optimal compression range, while having limited wear and tear.

As illustrated in FIG. 2, the first element 11 comprises a concave stopper portion 6 adapted to cooperate with the second element 12 in an extreme configuration of the lamp 1, in other words, when the first tilt angle S21 is very significant.

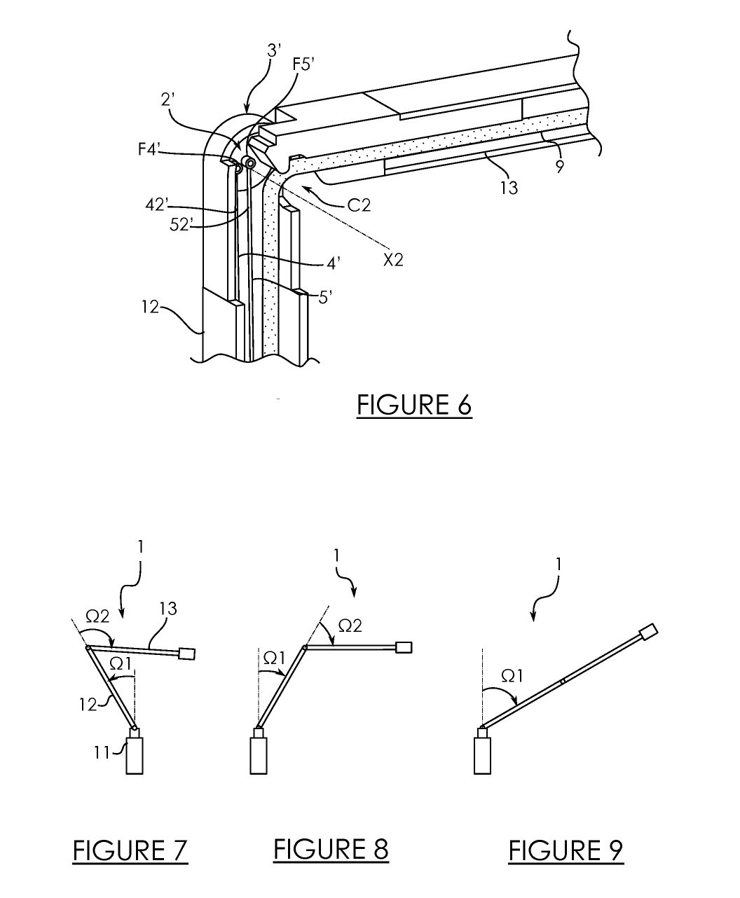

As indicated above, the first hinge C1 and the second hinge C2 are similar to one another but are assembled inverted as illustrated in FIG. 6. To this end, the second hinge C2 comprises a first tension spring 4′ and a second tension spring 5′, each tension spring 4′, 5′ having an end (not represented) connected to the second element 12 and an end 42′, 52′ connected to the second cylinder 2′ of the third element 13 according to a fastening point F4′, F5′, the fastening points F4′, F5′ of the tension springs 4′, 5′ being separate from one another and situated away from the axis X2 of the second cylinder 2′ so as to generate a tension torque around said second cylinder axis X2 between the second element 12 and the third element 13.

In a preferred manner, the tension springs 4, 5 of the first hinge C1 have a constant spring, higher than those of the second hinge C2, given that they must support a longer cantilevered length.

In a preferred manner, the second element 12 comprises a structural frame, to which are connected the springs 4, 5, and a jacket or casket surrounding said structural frame. In addition to the advantageous mechanical performance thereof, the second element 12 enables to offer a complimentary aesthetic aspect thanks to the jacket thereof.

The functioning of the first hinge C1 will thus be presented theoretically in reference to FIGS. 4 and 5, the functioning of the second hinge C2 being similar.

In this example, the first element 11 corresponds to the base of the lamp 1 and remains fastened. The second element 12 can be moved in relation to the first element 11 while remaining immobile after movement. In other words, the position of the second element 12 must be stable after modifying the first tilt angle S21.

As illustrated in FIG. 4, in a first position, the first tilt angle S21 is equal to 180°, the first element 11 and the second element 12 being aligned. The cantilever is weak and the drive torque aiming to move the second element 12 is also weak.

The two tension springs 4, 5 act on the first cylinder 2 so as to flatten it against the first housing 3. In this first position, the first tension spring 4 is slightly tense whereas the second tension spring 5 is slightly tenser. This results in few elastic forces transiting into the first hinge C1 to keep the second element 12 immobile. The offsetting of the fastening points F4, F5 of the tension springs 4, 5 enables, like a kite, to control the positioning of the second 12 by applying a weak tension torque opposing the weak drive torque.

Also, it is simple for a user to modify the position of the second element 12 into a second position wherein the first tilt angle S21 is equal to 40° as illustrated in FIG. 5. In this second position, the second tension spring 5 is very tense whereas the first tension spring 5 is even tenser. This results in the significant elastic forces transiting into the first hinge C1 which tends to apply a tension torque to the second element 12 to compensate for the strong drive torque connected to the cantilever. Because of the flattening brought about by the tension springs 4, 5, the friction between the first cylinder 2 and the housing 3 is also significant and prevents any movement, the position of the second element 12 being stable. Thus, even with a significant cantilever, the second element 12 remains fastened.

Advantageously, the friction of the first hinge C1 is more significant when static than when dynamic (or kinetic), which enables an operator to be able to easily modify the position of the second element 12 independently from the first tilt angle S21, the second element 12 remaining immobile after the movement thereof. The use of stainless steel surfaces also improves the performance, dynamically as it does statically, the lifespan of the first hinge C1 also being improved.

Several different positions of the lamp 1 according to the invention are represented in reference to FIGS. 7 to 9. The more the centre of gravity of the lamp 1 is offset in relation to the base thereof, the more the tension springs 4, 5, 4′, 5′ are applied to create a tension torque and a friction force enabling the lamp 1 to remain stable in position.

As illustrated in FIG. 9 wherein the lamp head is distant from the base thereof, the tension springs 4, 5 of the first hinge C1 are strongly applied so as to give a tension torque and a friction force to compensate for the drive torque brought about by the weight of the cantilevered lamp head.

Thanks to the invention, an architect's lamp is obtained, of which the hinged body does not comprise protruding portions and of which the design is simple and inexpensive compared with a hinged body with a linkage system.

The invention also aims for an industrial handling arm comprising, at the free end thereof, a sideboard, for example a plate, in order to facilitate the temporary storage of tools or parts. It goes without saying, that the type of tension springs used are adapted to the sizes and forces received by the industrial arm.

1. Hinged device comprising a free end intended to support a cantilevered load, the device comprising at least one first element and a second element connected by a hinge comprising a cylinder secured to said first element and a housing secured to said second element which are hinged together along an axis of said cylinder, the hinge comprising at least one first tension spring and a second tension spring, each tension spring having an end connected to the second element and an end connected to the cylinder of the first element according to a fastening point, the fastening points of the tension springs are separate from one another and situated away from the cylinder axis so as to generate a torque around said cylinder axis between the first element and the second element in order to oppose the torque brought about by the cantilever.

2. Device according to claim 1, wherein the first tension spring and the second tension spring extend longitudinally, each tension spring comprising a helicoidal body, the helicoidal body of the first tension spring and the helicoidal body of the second tension spring are longitudinally offset.

3. Device according to claim 1, wherein the fastening points of the tension springs are situated at the same distance from the cylinder axis.

4. Device according to claim 1, wherein the fastening points of the tension springs are spread in relation to the cylinder axis at a non-zero spread angle.

5. Device according to claim 1, wherein the fastening points of the tension springs are spread in relation to the cylinder axis at a spread angle of between 40° and 60°.

6. Device according to claim 1, wherein the tension springs are configured to flatten the cylinder against the housing in order to generate a friction force limiting the rotation of the first element in relation to the second element around said cylinder axis.

7. Device according to claim 1, wherein the cylinder comprises two cylindrical portions axially offset along the cylinder axis so as to conserve between them an assembly slot of the tension springs.

8. Device according to claim 1, comprising an electrical connection cable extending between the first element and the second element through the hinge.

9. Device according to claim 7, wherein the electrical connection cable extends into said assembly slot.

10. Device according to claim 1, wherein the first element and the second element being connected by a first hinge, the device comprises a third element connected to the second element by a second hinge, similar to the first hinge, which comprises a second cylinder secured to said third element and a second housing secured to said second element which cooperate along an axis of said second cylinder.

11. Device according to claim 10, wherein the third element is connected to a lamp head.
